(19) United States
(12) Patent Application Publication
(10) Pub. No.: US 2019/0180237 A1
(43) Pub. Date: Jun. 13, 2019

(54) SYSTEMS AND METHODS FOR DELIVERING MERCHANDISE USING A NETWORK OF UNMANNED AERIAL VEHICLES

(71) Applicant: Walmart Apollo, LLC, Bentonville, AR (US)

(72) Inventors: Todd D. Mattingly, Bentonville, AR (US); John J. O'Brien, Farmington, AR (US); Donald R. High, Noel, MO (US); Robert L. Cantrell, Herndon, VA (US); Brian G. McHale, Chadderton Oldham (GB)

(21) Appl. No.: 16/211,009

(22) Filed: Dec. 5, 2018

Related U.S. Application Data
(60) Provisional application No. 62/597,000, filed on Dec. 11, 2017.

(51) Int. Cl. G06Q 10/08; H04W 12/02; H04L 9/08; G05D 1/10; G05D 1/00; B64C 39/02

(52) U.S. Cl. CPC G06Q 10/08355; H04W 12/02; H04L 9/0825; G05D 1/104; B64C 2201/146; B64C 39/024; B64C 2201/027; B64C 2201/128; G05D 1/0027

(57) ABSTRACT

In some embodiments, systems and methods are provided herein useful to the secure delivery of merchandise using unmanned aerial vehicles forming a delivery chain. In some embodiments, the system includes: multiple unmanned aerial vehicles (UAVs) in which each UAV includes a motorized flight system, a navigational system, a merchandise storage system, a memory, a transceiver, and a UAV control circuit. The system further includes: a UAV delivery chain including a starting location, a delivery location, and one or more intermediate transfer locations; and a centralized storage and processing node configured to host a hash chain database containing delivery parameters of the UAVs. In the system, each UAV control circuit is configured to communicate with and cause the centralized node to: retrieve delivery parameters assigned to the UAV, decrypt the delivery parameters; identify another UAV as a transferee to accept receipt of the merchandise, and update the hash chain database.

### CROSS-REFERENCE TO RELATED APPLICATION

This application claims the benefit of U.S. Provisional Application No. 62/597,000, filed Dec. 11, 2017, which is incorporated by reference in its entirety herein.

### TECHNICAL FIELD

This invention relates generally to the delivery of merchandise, and more particularly, to the delivery of merchandise using unmanned aerial vehicles.

### BACKGROUND

In the retail setting, one important challenge is the delivery of merchandise to customers. Frequently, customers will order merchandise for delivery to their residence or other delivery location within a certain scheduled time. Various delivery methods are available, including the use of a retailer's delivery vehicles and third party delivery services. Recently, efforts have been made to employ unmanned aerial vehicles to complete deliveries to customers.

The use of unmanned aerial vehicles, however, presents its own challenges. Unmanned aerial vehicles may have a power source that is only sufficient to allow the unmanned aerial vehicle to travel a limited distance. In some instances, a specialty or unique merchandise item may have to be transferred a relatively long distance to the customer in a relatively short period of time. Thus, in some instances, it may be desirable to have multiple unmanned aerial vehicles form a delivery chain in which each unmanned aerial vehicle flies a leg of the delivery chain and transfers the merchandise item to another unmanned aerial vehicle. In these circumstances, it is also desirable to arrange for the secure and authenticated transfer and delivery of the merchandise item, such as through the use of blockchain.

### BRIEF DESCRIPTION OF THE DRAWINGS

Disclosed herein are embodiments of systems, apparatuses and methods pertaining to delivering merchandise using autonomous ground vehicles in cooperation with unmanned aerial vehicles. This description includes drawings, wherein:

FIG. 1 is a schematic representation in accordance with some embodiments;

FIG. 2 is a block diagram in accordance with some embodiments;

FIG. 3 is a block diagram in accordance with some embodiments;

FIG. 4 is a flow diagram in accordance with some embodiments;

FIG. 5 is a flow diagram in accordance with some embodiments;

FIG. 6 is a block diagram in accordance with some embodiments;

FIG. 7 is a block diagram in accordance with some embodiments;

FIG. 8 is a flow diagram in accordance with some embodiments;

FIG. 9 is a flow diagram in accordance with some embodiments;

FIG. 10 is a block diagram in accordance with some embodiments;

FIG. 11 is a block diagram in accordance with some embodiments;

FIG. 12 is a flow diagram in accordance with some embodiments;

FIG. 13 is a flow diagram in accordance with some embodiments;

FIG. 14 is a block diagram in accordance with some embodiments; and

FIG. 15 is a block diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for the secure delivery of merchandise using a plurality of unmanned aerial vehicles forming a delivery chain. In some embodiments, there is provided a system comprising: a plurality of unmanned aerial vehicles (UAVs) for transporting a merchandise item, each UAV comprising: a motorized flight system configured to facilitate flight of the UAV; a navigational system for guiding the UAV along a flight path; a merchandise storage or securement system configured to hold at least one merchandise item during flight; a memory device; a transceiver configured for wireless communication; a UAV control circuit operatively coupled to the motorized flight system, the navigational system, and the transceiver, the control circuit configured to operate and fly the UAV; a UAV delivery chain including a starting location wherein a starting UAV receives the merchandise item, a delivery location wherein a delivery UAV delivers the merchandise item, and one or more intermediate transfer locations between the starting and delivery locations wherein one of the plurality of UAVs transfers the merchandise item to another one of the plurality of UAVs; a centralized storage and processing node configured to host a hash chain database containing delivery parameters associated with each of the plurality of UAVs and to update the hash chain database; wherein each UAV control circuit is configured to communicate with the centralized node, via the transceiver, to cause the centralized node to: retrieve delivery parameters assigned to the UAV from the hash chain database wherein the delivery parameters for the UAV is at least partially encrypted at the centralized node; decrypt the delivery parameters assigned to the UAV with a public or private key of the UAV assigned to the UAV; identify another UAV as a transferee to accept receipt of the merchandise item or, if the UAV is the delivery UAV, identify the delivery location wherein the delivery UAV delivers the merchandise item; and update the hash chain database with a new block comprising a hash of preceding data in the hash chain database and delivery parameters encrypted with a public or private key of the UAV.

In the system, in some implementations, the centralized node comprises a remote server and the hash chain database is stored on the remote server, each control circuit being configured to access the hash chain database and/or the delivery parameters from the remote server via each UAV's transceiver. In some implementations, the centralized node is physically incorporated into a dedicated master UAV of the plurality of UAVs, the dedicated master UAV configured with sufficient storage and processing capability to host and update the hash chain database. In some implementations, the hash chain database comprises a blockchain in which each block corresponds to delivery parameters for one of the plurality of UAVs. In some implementations, one or more blocks in the hash chain database comprise identification information of transferee UAVs assigned to accept receipt of the merchandise item from transferring UAVs. In some implementations, the control circuit of each transferring UAV is further configured to communicate with the centralized node to authenticate the transferee UAV based on vehicle registry information stored in the hash chain database. In some implementations, the delivery parameters for each UAV comprise at least one of the location coordinates for receipt of the merchandise item from a UAV transferring the merchandise item, authentication information for the transferring UAV, the location coordinates for transfer of the merchandise item to a transferee UAV, the authentication information for the transferee UAV, and the coordinates of the delivery location. In some implementations, the merchandise storage or securement mechanism of each UAV comprises a gripper mechanism configured to selectively grasp, hold, and release the merchandise item. In some implementations, a private key for each UAV is stored in the UAV's memory device and is transmitted to the centralized node for decrypting the UAV's delivery parameters at the centralized node. In some implementations, each UAV transmits a unique identification code associated with the UAV to the centralized node to allow the centralized node to determine the UAV's private key for decrypting the UAV's delivery parameters at the centralized node.

In another form, there is provided a method for the secure delivery of merchandise using a plurality of unmanned aerial vehicles forming a delivery chain, the system comprising: providing a plurality of unmanned aerial vehicles (UAVs) for transporting a merchandise item, each UAV comprising: a motorized flight system configured to facilitate flight of the UAV; a navigational system for guiding the UAV along a flight path; a merchandise storage or securement system configured to hold at least one merchandise item during flight; a memory device; a transceiver configured for wireless communication; a UAV control circuit operatively coupled to the motorized flight system, the navigational system, and the transceiver, the control circuit configured to operate and fly the UAV; defining a UAV delivery chain including a starting location wherein a starting UAV receives the merchandise item, a delivery location wherein a delivery UAV delivers the merchandise item, and one or more intermediate transfer locations between the starting and delivery locations wherein one of the plurality of UAVs transfers the merchandise item to another one of the plurality of UAVs; by a centralized storage and processing node, hosting a hash chain database containing delivery parameters associated with each of the plurality of UAVs and updating the hash chain database; by each UAV control circuit, communicating with the centralized node, via the transceiver, to cause the centralized node to: retrieve delivery parameters assigned to the UAV from the hash chain database wherein the delivery parameters for the UAV is at least partially encrypted at the centralized node; decrypt the delivery parameters assigned to the UAV with a public or private key of the UAV assigned to the UAV; identify another UAV as a transferee to accept receipt of the merchandise item or, if the UAV is the delivery UAV, identify the delivery location wherein the delivery UAV delivers the merchandise item; and update the hash chain database with a new block comprising a hash of preceding data in the hash chain database and delivery parameters encrypted with a public or private key of the UAV.

In another form, there is provided a system for the secure delivery of merchandise using a plurality of unmanned aerial vehicles forming a delivery chain, the system comprising: a plurality of unmanned aerial vehicles (UAVs) for transporting a merchandise item, each UAV comprising: a motorized flight system configured to facilitate flight of the UAV; a navigational system for guiding the UAV along a flight path; a merchandise storage or securement system configured to hold at least one merchandise item during flight; a memory device; a transceiver configured for wireless communication; a UAV control circuit operatively coupled to the motorized flight system, the navigational system, and the transceiver, the control circuit configured to operate and fly the UAV; a UAV delivery chain including a starting location wherein a starting UAV receives the merchandise item, a delivery location wherein a delivery UAV delivers the merchandise item, and one or more intermediate transfer locations between the starting and delivery locations wherein one of the plurality of UAVs transfers the merchandise item to another one of the plurality of UAVs; a hash chain database containing delivery parameters associated with each of the plurality of UAVs; wherein each UAV control circuit is configured to: retrieve delivery parameters assigned to the UAV from the hash chain database wherein the delivery parameters for the UAV is at least partially encrypted; decrypt the delivery parameters assigned to the UAV with a public or private key of the UAV assigned to the UAV; identify another UAV as a transferee to accept receipt of the merchandise item or, if the UAV is the delivery UAV, identify the delivery location wherein the delivery UAV delivers the merchandise item; and update the hash chain database with a new block comprising delivery parameters encrypted with a public or private key of the UAV.

As addressed further below, this disclosure is directed generally to a mesh network of delivery agents (in the form of UAVs) where a delivery may pass from delivery agent to delivery agent (a “relay race”) until reaching the customer or other final destination. In one form, the network of delivery agents may be managed by a central system and may be reconfigurable during delivery. The concept may include an authentication method (“blockchain authentication”) for delivery agents to authenticate delivery agents as the delivery transitions from agent to agent. In one form, the use of blockchain authentication may confirm that the package being delivered by delivery agents to a customer during delivery was not tampered with or substituted for a different package.

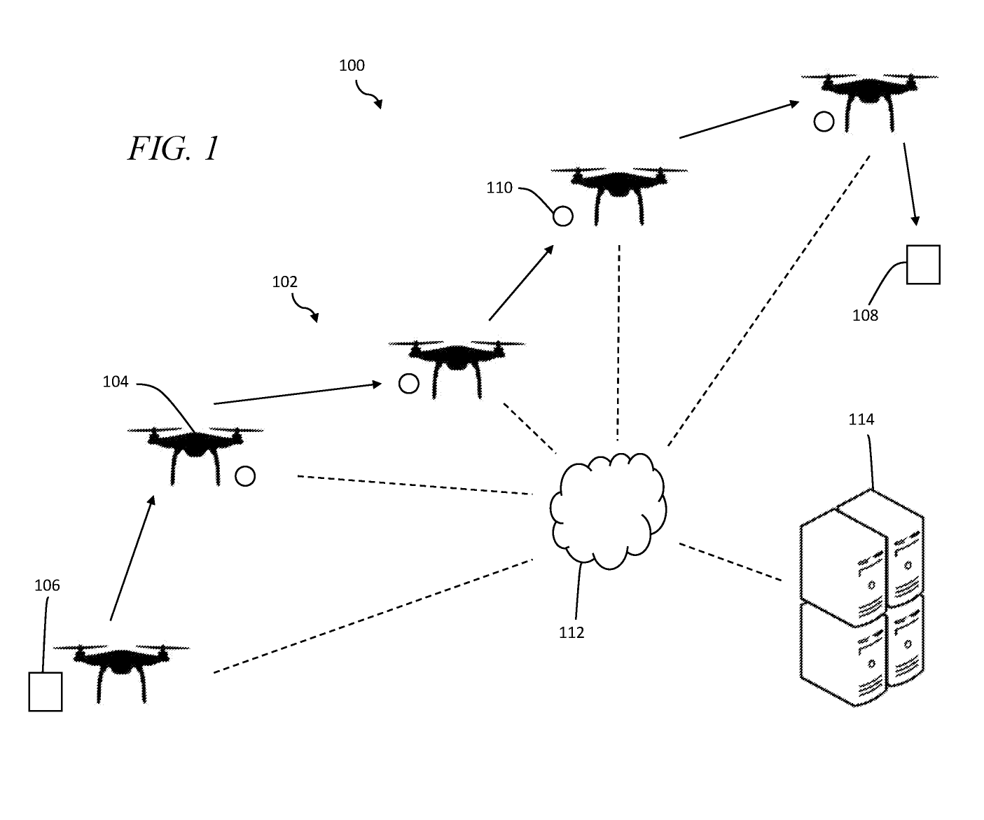

Referring to FIG. 1, there is shown a system 100 including a delivery chain 102 of UAVs 104 for delivering merchandise. It is generally contemplated that each UAV 104 will transport merchandise along one leg of the delivery chain 102, at which point the merchandise will be transferred to another UAV 104 that will then complete another leg of the delivery chain 102. The delivery chain 102 will include a starting location 106 where a starting UAV 104 receives a merchandise item and a delivery location 108 where the last UAV 104 (or delivery UAV) will complete delivery of the merchandise item. It will also include one or more intermediate transfer locations 110 between the starting and delivery locations 106, 108 where one UAV 104 will transfer the merchandise item to another one of the UAVs 104. The starting location 106 may be a commercial product distribution center, shopping facility, or other location where the merchandise item is available. The intermediate transfer locations 110 may be formally designated locations where multiple UAVs 104 are housed or collected, or they may be more informal locations where the UAVs 104 simply rendezvous with each other. The delivery location 108 may be a customer residence or customer designated location, or the delivery location 108 may be a commercial product distribution center, shopping facility, or other desired destination for the merchandise item.

In the system 100, the UAVs 104 may communicate with one another over a network 112. The system 100 may optionally include a server system 114 accessible by one or more of the UAV 104 over the network 112. Further, as explained below, the server system 114 may act as a centralized storage and processing node for the system 100.

It is generally contemplated that there may be a variety of circumstances where the use of a delivery chain 102 might be desirable. For example, UAVs 104 may have a limited range due to a power source that is only sufficient to allow the UAV 104 to travel a limited distance. So, it might be desirable to have multiple UAVs 104 involved so that they can travel a greater cumulative distance. In some instances, a specialty or unique merchandise item may have to be transferred a relatively long distance to the customer. Alternatively, a perishable merchandise item may have to be transported with little transit time so that it does not spoil or otherwise become unusable prior to delivery to a customer. In another circumstance, the time promised for delivery of the merchandise item to the customer may be very short such that the use of a tag-team arrangement of UAVs 104 may be desirable.

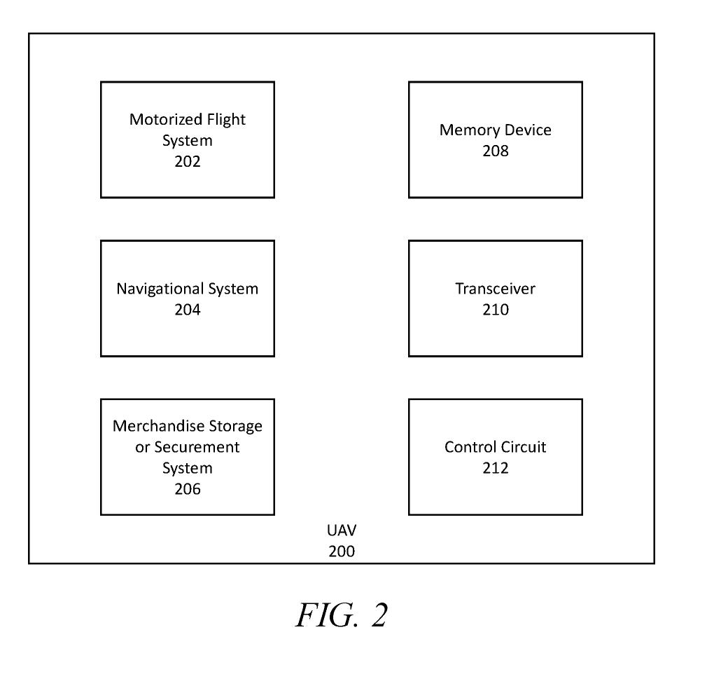

Referring now to FIG. 2, a UAV 200 for transporting merchandise in accordance to some embodiments is shown. It is generally contemplated that the UAV 200 includes certain components that allow it to transport merchandise. The UAV 200 includes a motorized flight system 202, a navigational system 204, a merchandise storage or securement system 206, a memory device 208, a transceiver 210, and a control circuit 212. In some embodiments, the UAV 200 may comprise a bicopter, a tricopter, a quadcopter, a hexacopter, an octocopter, etc. In some embodiments, the UAV 200 may be configured to carry packages and/or other types of cargo.

The UAV 200 includes a motorized flight system 202 configured to facilitate flight of the UAV 200. The motorized flight system 202 may comprise one or more motors that control one or more of a speed, direction, and/or orientation of one or more propellers on the UAV 200. The motorized flight system 202 may be configured to be controlled by the control circuit 212 to fly the UAV 200 in designated directions. In some embodiments, the motorized flight system 202 may comprise rotors and/or propellers on the UAV 200. In one form, the motorized flight system 202 may be navigated along a pre-programmed or calculated route from a starting point to a transfer/destination point (or to a waypoint near the destination point). Further, in one form, the motorized flight system 202 may be navigated by a human operator as it nears the transfer/destination point (which may be defined by a waypoint at the transfer/destination point) or for landing the UAV 200 because more expert navigation may be required at this stage.

The UAV 200 includes a navigational system 204 for guiding the UAV 200 along a flight path. The navigational system 204 includes sensor(s) for navigation and optionally for detecting obstacles in the UAV's flight path as it travels along its route. These sensor(s) may be of any of various types, including compasses and other navigational aids, gyroscopes, magnetometers, accelerometers, altitude sensors, radar laser range finders, ultrasound range finders, infrared sensors, and optical/imaging sensors (such as video/camera devices). It is also generally contemplated that the optical/imaging sensors may permit a human operator to remotely guide the UAV 200, such as for transferring the merchandise item or for landing the UAV 200. In some embodiments, the navigational system 204 may comprise one or more environmental sensors such as wind sensors, light sensors, visibility sensors, weather sensors, barometric pressure sensors, humidity sensors, sound sensors, thermal image sensors, night vision cameras, etc.

The UAV 200 also includes a merchandise storage or securement system 206 configured to hold at least one merchandise item during flight. The merchandise items may be of any type suitable for delivery, such as, for example, clothing, grocery, sporting goods, general retail merchandise, etc. In addition, the merchandise storage or securement system 206 may include a storage area that is refrigerated and/or insulated for the delivery of perishable items, such as frozen or refrigerated grocery items. Also, the storage area may be of any of various sizes and shapes. It may be relatively small for delivery of a single item per delivery and/or to conserve battery power. Alternatively, it may be relatively large to allow the storage of multiple merchandise items for delivery to different destinations.

The UAV 200 further includes a transceiver 210 configured for wireless communication. The transceiver 210 may comprise one or more of a WLAN transceiver, a WWAN transceiver, a mobile data network transceiver, a satellite network transceiver, a WiMax transceiver, a Wi-Fi transceiver, a Bluetooth transceiver, and the like. In some embodiments, the transceiver 210 may be configured to allow the control circuit 212 to communicate with the other UAVs 200 and a server system/central node. In some embodiments, the UAV 200 may be configured to autonomously travel for extended periods of time without communicating with another vehicle or with a central server/central node.

In addition, the UAV 200 includes a control circuit 212 operatively coupled to the motorized flight system 202, the navigational system 204, and the transceiver 210, the control circuit 212 configured to operate and fly the UAV 200. The control circuit 212 may comprise a processor, a microprocessor, and the like and may be configured to execute computer readable instructions stored on a computer readable storage memory 208. The computer readable storage memory 208 may comprise volatile and/or non-volatile memory and have stored upon it a set of computer readable instructions which, when executed by the control circuit 212, cause the control circuit 212 to navigate the UAV 200 and communicate with other devices. The architectural options for such structures are well known and understood in the art and require no further description here. The control circuit 212 is configured (for example, by using corresponding programming as will be well understood by those skilled in the art) to carry out one or more of the steps, actions, and/or functions described herein.

It is generally contemplated that the delivery chain of UAVs 200 will make use of a hash chain database and blockchain to ensure secure delivery of the merchandise item. In some embodiments, the hash chain database may comprise one or more of hashed records, a distributed database, a distributed ledger, a blockchain database, and the like. In some embodiments, a task record in the hash chain database may comprise an encrypted portion and an unencrypted portion. For example, the delivery parameters and authorizations required to travel the delivery route or portions thereof may be encrypted and only accessible to vehicle(s) assigned to a certain portion of the route, while general information and assigned UAV 200 information may be unencrypted and visible to other UAVs 200 and systems that share the hash chain database. In other words, delivery parameters may be assigned to each UAV 200 through a hash chain database associated with the delivery chain 102. In some embodiments, the hash chain database may comprise a chain of records in which each block in the chain comprises a hash of a previous block.

One challenge with the use of a hash chain database and blockchain, however, is that each UAV 200 may have only limited processing and/or storage capability, which may not be sufficient to handle the processing and/or storage demands associated with the hash chain database and blockchain. This disclosure therefore seeks to provide several different ways in which the hash chain database and blockchain may be used within the delivery chain 102 in order to reduce the processing and/or storage demands on the individual UAVs 200. These approaches generally include the following: (1) use of a centralized storage and processing node to host the hash chain database and to update blocks in the database; (2) storing the hash chain database in a distributed manner across the UAVs 200 so that the processing and/or storage demands do not fall fully upon any individual UAV 200 (each UAV 200 is treated as a separate node); (3) transfer of the hash chain database between UAVs 200 with subsequent deletion of any portion that cannot be decrypted by the UAV 200; and (4) deleting data relating to past transfers but updating the hash chain database with a new block indicating a successful and secure transfer of the merchandise item from a previous UAV 200. These approaches are described in more detail below.

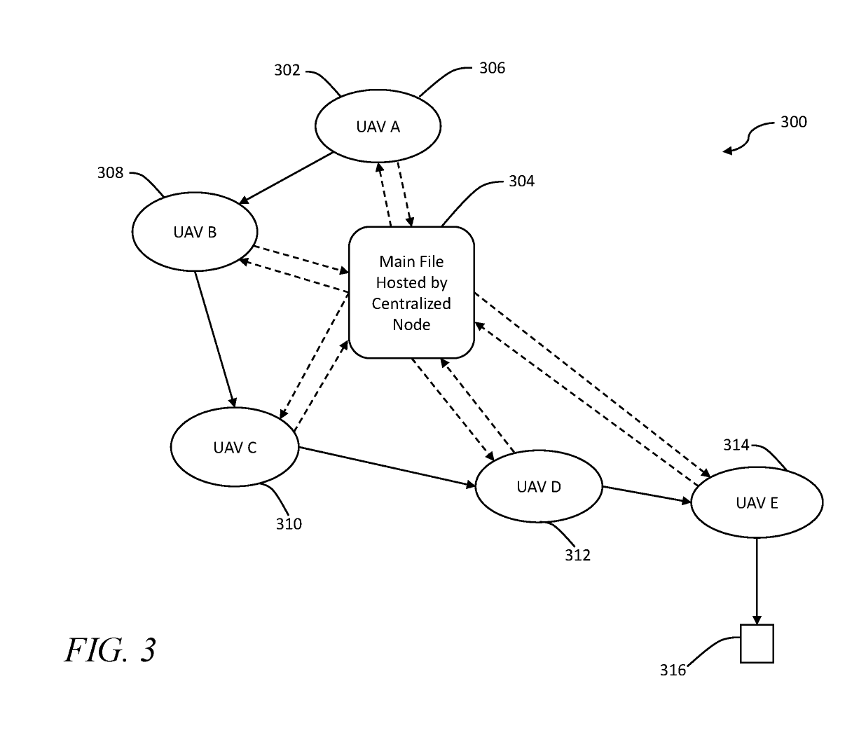

Referring to FIG. 3, there is shown a system 300 including a plurality of UAVs 302 that communicate with a centralized storage and processing node 304. The centralized node 304 hosts the hash chain database, and all or nearly all of the blockchain operations (modification and addition of blocks) are performed at the centralized node 304. It is contemplated that the centralized node 304 (which may be a server system) has the storage and processing capacity to perform the operations. In this manner, each UAV 302 is not required to perform operations that may overwhelm their storage and processing capability or that might result in sluggish functioning of the UAV 302.

In the example of system 300, there are five UAVs (UAV A (306), UAV B (308), UAV C (310), UAV D (312), and UAV E (314)). In this example, UAVs A, B, C, D and E may be used to deliver merchandise to a delivery location (at 316). As can be seen, each UAV 302 communicates back and forth with the centralized node 304.

In the system 300, the centralized storage and processing node 304 is configured to host the hash chain database containing delivery parameters associated with each of the UAVs 302 and to update the hash chain database. It is generally contemplated that the hash chain database may be at a remote server (such as at a remote command and control center or cloud-based platform). In other words, the centralized node 304 may include a remote server and the hash chain database may be stored on the remote server. Further, each UAV control circuit may be configured to access the hash chain database and/or the delivery parameters from the remote server via each UAV's transceiver.

Alternatively, the hash chain database need not be disposed at a remote command and control center or cloud-based platform, but may instead be disposed at a mothership. In other words, the centralized node 304 may be physically incorporated into a dedicated master UAV of the plurality of UAVs (such as, for example, UAV A (306)), and the dedicated master UAV may be configured with sufficient storage and processing capability to host and update the hash chain database. Thus, each delivery chain of UAVs might include one specialized UAV (in this example, UAV A (306)) with extra storage and/or processing capability, while the remaining UAVs are standard and interchangeable UAVs without this additional capability.

In the system 300, each UAV control circuit is configured to communicate with the centralized node 304, via the transceiver, to cause the centralized node 304 to perform certain operations. These operations include retrieving delivery parameters assigned to a particular UAV (such as, for example, UAV B (308)) from the hash chain database, and the delivery parameters for that particular UAV (in this example, UAV B (308)) are at least partially encrypted at the centralized node 304. The operations further include decrypting the delivery parameters assigned to that UAV (in this example, UAV B (308)) with a public or private key of the UAV assigned to the UAV. Other operations includes identifying another UAV (such as, for example, UAV C (310)) as a transferee to accept receipt of the merchandise item or, if the UAV is the delivery UAV, to identify the delivery location where the delivery UAV is to deliver the merchandise item. In addition, the centralized node 304 updates the hash chain database with a new block comprising a hash of preceding data in the hash chain database and delivery parameters encrypted with a public or private key of the UAV (such as, for example, indicating the successful and secure transfer of the merchandise item from UAV B (308) to UAV C (310)). By performing all of these operations at the centralized node 304 (which has a relatively high capability for storage and/or processing), the system operates in a smoother and more efficient manner and with a reduced likelihood of error. If these operations were to be performed by the UAV control circuits (which have a relatively low capability for storage and/or processing), the overall functioning of the UAVs 302 would be degraded unless the UAV control circuits' capability was significantly upgraded (resulting in increased cost and possibly reduced flight operations of the UAVs 302).

In the system 300, it is contemplated that the hash chain database will include delivery parameters for each UAV 302. It is generally contemplated that these delivery parameters will generally define the flight information needed by each UAV 302 to complete its flight path and to indicate successful and secure transfers of the merchandise item. These delivery parameters may include, for example, the location coordinates for receipt of the merchandise item from a UAV transferring the merchandise item (such as, for example, UAV B (308)), authentication information for the transferring UAV (in this example, UAV B (308), the location coordinates for transfer of the merchandise item to a transferee UAV (such as, for example, UAV C (310)), the authentication information for the transferee UAV (in this example, UAV C (310), and the coordinates of the delivery location. In one form, the hash chain database may comprise a blockchain in which each block corresponds to delivery parameters for one of the UAVs 302.

In the system 300, it is also contemplated that the hash chain database includes identification information of the UAVs 302. In other words, one or more blocks in the hash chain database may comprise identification information of a transferee UAV (such as, for example, UAV C (310)) assigned to accept receipt of the merchandise item from a transferring UAV (such as, for example, UAV B (308)). It is contemplated that a transferee UAV (in this example, UAV C (310)) may have to be authenticated as an authorized UAV to receive the merchandise item prior to the transfer from the transferring UAV (in this example, UAV B (308)). For example, in one form, the control circuit of each transferring UAV (in this example, UAV B (308)) may be configured to communicate with the centralized node 304 to authenticate the transferee UAV (in this example, UAV C (310)) based on vehicle registry information stored in the hash chain database.

Further, it is contemplated that, at least, certain portions of the delivery parameters will be encrypted and a private key will be used in the decryption. In one form, each UAV 302 may have or be associated with a private key. In this form, the private key for each UAV 302 may be stored in the UAV's memory device and may be transmitted to the centralized node 304 to be used for decrypting that UAV's delivery parameters at the centralized node 304. In another form, a private key corresponding to each UAV 302 may be kept at the centralized node 304, but each UAV 302 may have a unique identifier to determine its private key at the centralized node 304. In other words, each UAV 302 may transmit a unique identifier or identification code associated with the UAV 302 to the centralized node 304 to allow the centralized node 304 to determine the UAV's private key for decrypting the UAV's delivery parameters at the centralized node 304.

During the course of the delivery, there will be one or more transfers of the merchandise item from a transferring UAV to a transferee UAV. In system 300, UAV A (306) transfers the merchandise to UAV B (308), UAV B (308) later transfers it to UAV C (310), UAV C (310) then transfers the merchandise to UAV D (312), UAV D (312) transfer it to UAV E (314), and UAV E (314) flies the last leg of the delivery chain to the delivery location 316. The physical transfer may be handled in various ways. For example, in one form, a transferring UAV 302 may land at a designated intermediate transfer depot, and a human operator may manually transfer the merchandise item to the transferee UAV 302. The merchandise storage or securement system of each UAV may include a cavity, pocket, or other storage area for holding the merchandise item during flight. In another form, or in addition, the merchandise storage of securement system of each UAV 302 may include a gripper mechanism configured to selectively grasp, hold, and release the merchandise item. This gripper mechanism may allow for the transfer of the merchandise item between UAVs without the intervention of a human operator and may dispense with the need for a designated intermediate transfer depot.

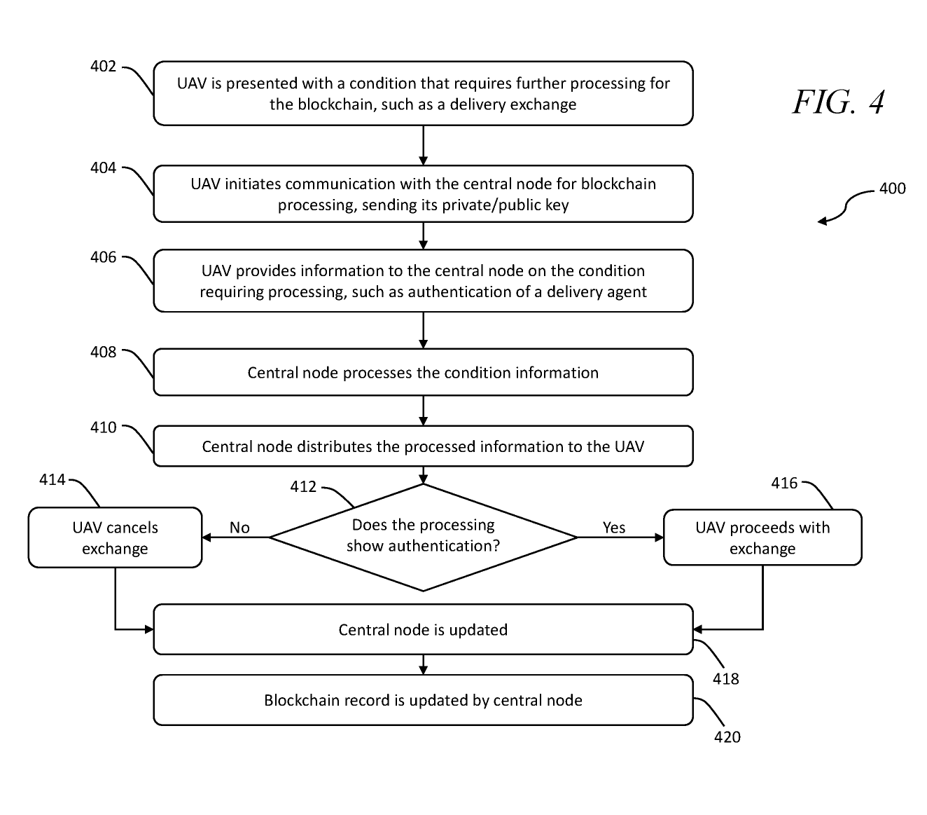

Referring to FIG. 4, there is shown a process 400 for the secure delivery of merchandise using UAVs forming a delivery chain. More specifically, the process 400 shows the interaction between a UAV and a central node hosting a hash chain database or blockchain. The process 400 may use some or all of the components described above.

At block 402, one of the UAVs in the delivery chain encounters a condition/delivery parameter that requires further processing involving the hash chain database/blockchain. For example, in block 402, a transferring UAV may be nearing the end of its flight leg. The transferring UAV may be preparing for transfer of a merchandise item to a receiving/transferee UAV that will fly the next leg of the delivery chain.

At block 404, the receiving/transferee UAV initiates communication with the central node for blockchain processing. As described above, this central node may take any of various forms. For example, it may be at a remote command and control center or cloud-based platform, or it may be a dedicated mothership UAV that has relatively greater storage and/or processing capability than the other UAVs. In this example, the receiving UAV may transmit a private or public key to the central node to facilitate further processing at the central node.

At block 406, the receiving UAV also provides information to the central node on the condition/delivery parameter requiring processing. In other words, the information required is communicated to the central node. In this particular example, the receiving UAV seeks information regarding authentication of the transferring UAV/delivery agent that is transferring the merchandise. In other words, the receiving UAV seeks confirmation that the transferring UAV is an authorized UAV. It is also contemplated that the authentication may be handled (in the alternative or in addition) by the transferring UAV. In other words, the transferring UAV may seek confirmation that the receiving UAV is an authorized UAV for handoff of the merchandise.

At block 408, the central node processes the condition/delivery parameter information. In this example, it determines whether the transferring UAV and/or the receiving UAV are authorized UAVs. It may make this determination, for example, based on public and private keys transmitted by the UAV(s) or based on unique identifiers associate with the UAV(s). At block 410, following the determination, the central node distributes the processed information to one or both of the transferring and receiving UAVs.

At block 412, the process 400 takes different actions depending on whether processing confirms authentication of the transferring and/or receiving UAV. At block 414, if it does not confirm authentication, the exchange or transfer of the merchandise is cancelled. In other words, either the transferring UAV or the receiving UAV are determined to not be authorized UAVs, so the transfer will not proceed. At block 416, if authentication is confirmed, the exchange or transfer of the merchandise proceeds. In other words, the transferring UAV and/or receiving UAV are determined to be authorized.

At block 418, in either situation, the central node is updated with this authentication/non-authentication information. At block 420, the blockchain record is updated by the central node. For example, if authentication is confirmed and if the transfer is made, a new block may be created to reflect this authentication and/or to reflect a successful and secure transfer of the merchandise item. On the other hand, if authentication is not confirmed and no transfer is made, a new block may be created to reflect this information.

The process 400 is intended to generally include the handling of a variety of conditions/delivery parameters, not just the example provided above. In other words, the process 400 is not limited to just the condition of authentication of one or both UAVs during exchange of the merchandise item from one to the other. The process 400 may also involve the handling of other delivery parameters, which may be handled at the central node. For example, the delivery parameters may relate to the flight information of a UAV, such as coordinates for the UAV's destination in its leg of the delivery chain. The central node may transmit this delivery parameter information to the UAV. Once this information is received from the central node, the UAV may then be able to calculate a flight path to this destination (or the flight path itself may be a delivery parameter received from the central node).

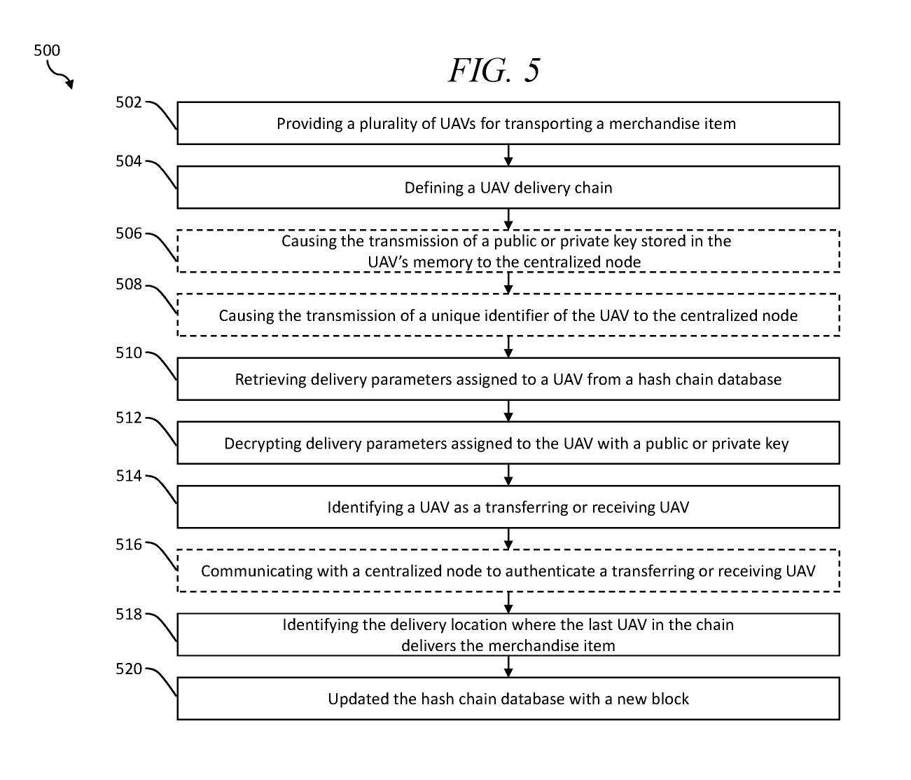

Referring to FIG. 5, there is shown a process 500 for the delivery of merchandise using multiple UAVs that transfer a merchandise item in a tag-team sort of arrangement. More specifically, each UAV flies along one leg of a delivery chain and transfers the merchandise item to another UAV. Further, the UAVs communicate and interact with a central node hosting a hash chain database or blockchain to facilitate multiple secure and authenticated handoffs of the merchandise item between the multiple UAVs. The process 500 may use some or all of the components described above.

At block 502, a plurality of UAVs are provided for transporting a merchandise item. The UAVs need not deliver just one merchandise item and may be configured to transfer several merchandise items during one delivery. Further, it is contemplated that any of various types of merchandise may be transporting, including, for example, perishable merchandise, specialty items, clothing, grocery, sporting goods, general retail merchandise, etc.

At block 504, a UAV delivery chain is defined. It is generally contemplated that the UAVs in the chain will be disposed at geographically separated locations so that each UAV will have sufficient battery power to fly its leg of the delivery chain to another UAV that will receive transfer of the merchandise. The last UAV in the chain will have sufficient battery power to fly the last leg of the chain to the ultimate delivery location. In one form, the UAVs may be located at designated transfer depots or centers housing multiple UAVs.

At blocks 506 and 508, it is contemplated optionally that a public or private key assigned to each UAV is used at the central node for decryption. At block 506, the public or private key stored in the UAV's memory is caused to be transmitted to the centralized node. In another form, at block 508, a unique identifier of the UAV (such as, for example, a numeric code) is caused to be transmitted to the centralized node. In turn, this unique identifier may be used at the central node to look up the public or private key assigned to that UAV. It is generally contemplated that the public or private key assigned to each UAV may be used to decrypt delivery conditions or parameters assigned to that UAV.

At blocks 510 and 512, the delivery conditions or parameters are retrieved and decrypted. At block 510, delivery parameters assigned to a UAV are retrieved from a hash chain database. For example, the delivery parameters may include the flight path or flight destination for the UAV where a transfer is to be made to another UAV. At block 512, the delivery parameters assigned to the UAV are decrypted with the public or private key. The central node decrypts the delivery parameters for that UAV, such as, for example, the specific flight information for that UAV's leg of the delivery chain.

At blocks 514 and 516, the transferring and/or receiving UAVs are identified and/or authenticated prior to transfer of the merchandise item from one to the other. At block 514, a transferring and/or receiving UAV is identified. This identification may occur at the same time as any authentication or prior to any authentication. At block 516, a transferring and/or receiving UAV optionally communicates with the centralized node to authenticate the other UAV. For example, a transferring UAV may communicate with the centralized node to authenticate the receiving UAV to determine that it is an authorized UAV for receipt of the merchandise item.

At block 518, the delivery location where the last UAV delivers the merchandise is identified. It is generally contemplated that the destination location for each UAV is identified and that, at the destination location, the merchandise is transferred to the next UAV in the chain. However, this transfer does not occur for the last UAV in the chain. Instead, the last UAV in the chain travels to its destination location (the delivery location) but does not transfer the merchandise to another UAV. It delivers the merchandise to the last stop in the chain, i.e., to a customer, commercial product distribution center, shopping facility, etc.

At block 520, the hash chain database is updated with a new block. It is generally contemplated that the hash chain database may be updated at several different stages in the process 500. For example, it may be updated when a UAV receives delivery parameters from the central node, such as flight destination and flight path, which may occur at various times. For instance, the UAVs may all receive their individual flight delivery parameters at the same time at the beginning of the delivery (when the first UAV starts its flight), or each UAV may receive its particular flight delivery parameters when it begins flying its leg of the delivery chain. As another example of an update, the hash chain database may be updated whenever a transferring or receiving UAV confirms that a successful transfer was made.

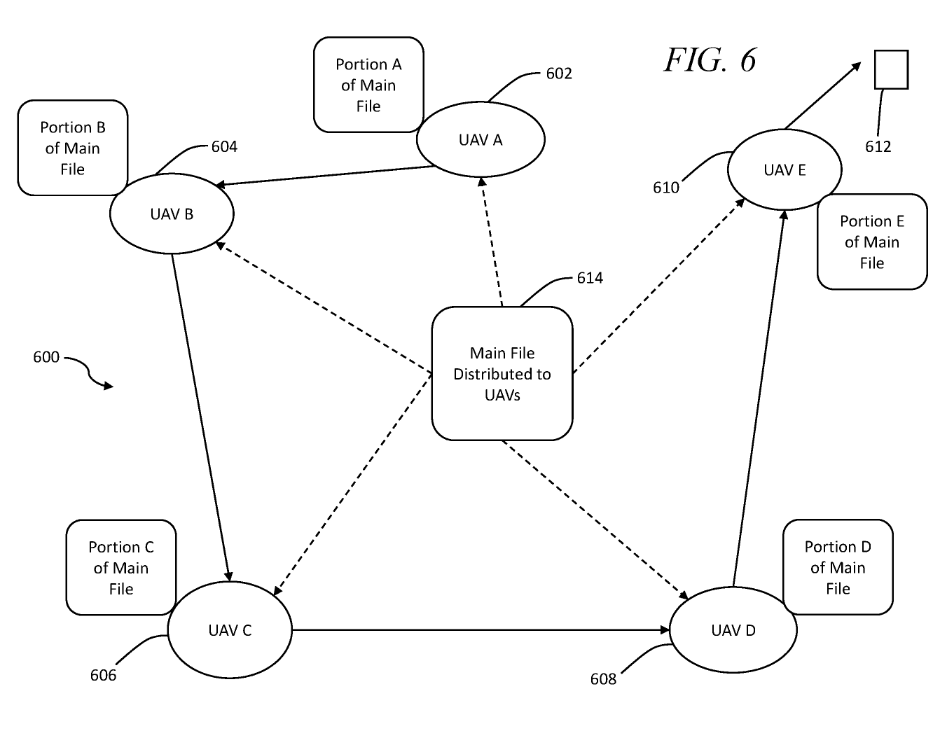

Referring to FIG. 6, there is shown an alternative system 600 for using multiple UAVs forming a delivery chain to deliver merchandise items. This system 600 generally involves storing the hash chain database in a distributed manner across the UAVs so that the processing and/or storage demands do not fall fully upon any individual UAV. In other words, each UAV is treated as a separate node that stores only a portion of the main file. Rather than transferring the entire hash chain database from one UAV to the next, the hash chain database is distributed to the memory devices of the UAVs, and blockchain operations are performed locally at the UAVs. This approach is in contrast to the system 300 described above, which involved the use of a centralized storage and processing node to host the hash chain database.

The system 600 generally involves the UAVs 200 having the same components as described above (motorized flight system 202, navigational system 204, merchandise storage or securement system 206, memory device 208, transceiver 210, and control circuit 212). Like system 300, in the example of system 600, there are five UAVs (UAV A (602), UAV B (604), UAV C (606), UAV D (608), and UAV E (610)). In this example, the UAVs A, B, C, D and E are being used to deliver merchandise to a delivery location (at 612). The hash chain database is stored on a distributed database comprising the memory devices 208 of the UAVs. In one form, a public key may allow all of the UAVs access to the entire database, but this approach may be reliant on continuous connectivity. Alternatively, as can be seen, each UAV may receive a portion of the main file from a centralized node or database 614 (which may, for example, be physically maintained at a remote command and control center or at a cloud based platform).

Under this approach, in one form, it is generally contemplated that the hash chain database (main file) may initially be stored at the centralized node 614. Further, it is contemplated that a portion of the hash chain database may be transmitted to each UAV prior to or at the time the first UAV initiates the delivery (although these portions may be transmitted at other times). In addition, it is contemplated that each UAV may receive a portion of the hash chain database that relates to that particular UAV (such as flight path, flight destination, identity of the UAVs from which it will receive the merchandise item and/or to which it will transfer the merchandise item, etc.) In one form, each UAV will transmit its public and/or private key to the centralized node 614, and in response, the centralized node 614 may transfer the corresponding portion of the main file to each UAV.

Further, in this form, blockchain operations may be handled locally at the UAVs. For example, if authentication of a transferring/receiving UAV is confirmed and if a transfer is made, a new block may be created to reflect this authentication and/or to reflect a successful and secure transfer of the merchandise item. On the other hand, if authentication is not confirmed and/or no transfer is made, a new block may be created to reflect this information. In addition, in one form, at the completion of the delivery, each of the UAVs may transfer its portion of the file (which has been updated) back to remote command and control center, cloud based platform, etc., housing the centralized node 614. An independent check may then be performed of the updated file portions to confirm successful and secure transfer of the merchandise item along the entirety of the delivery chain.

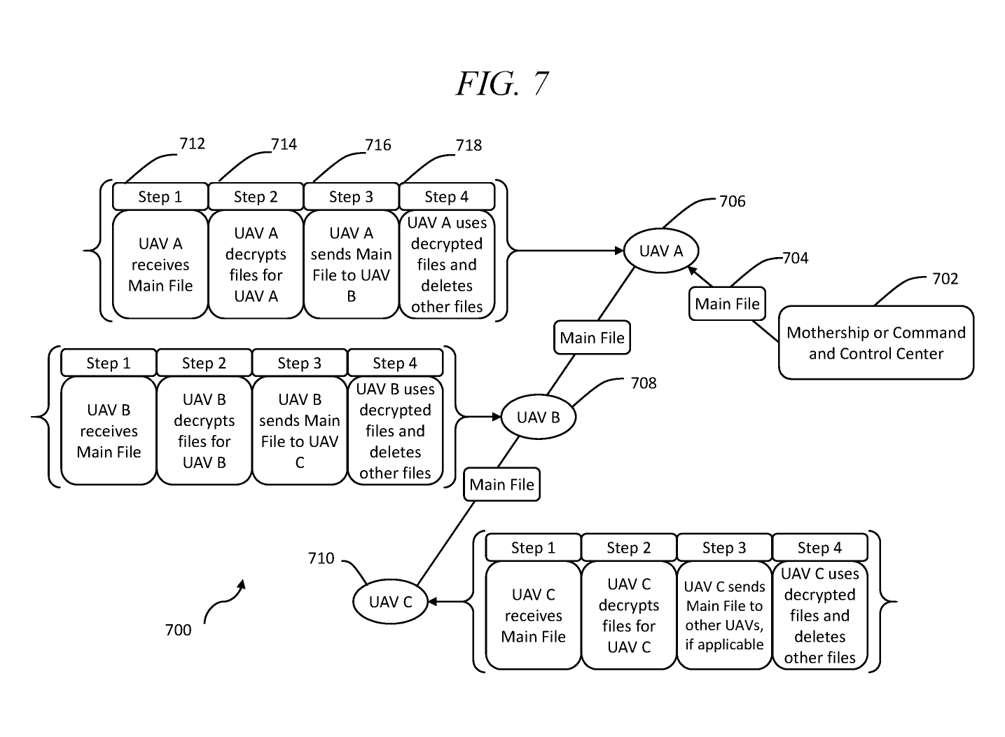

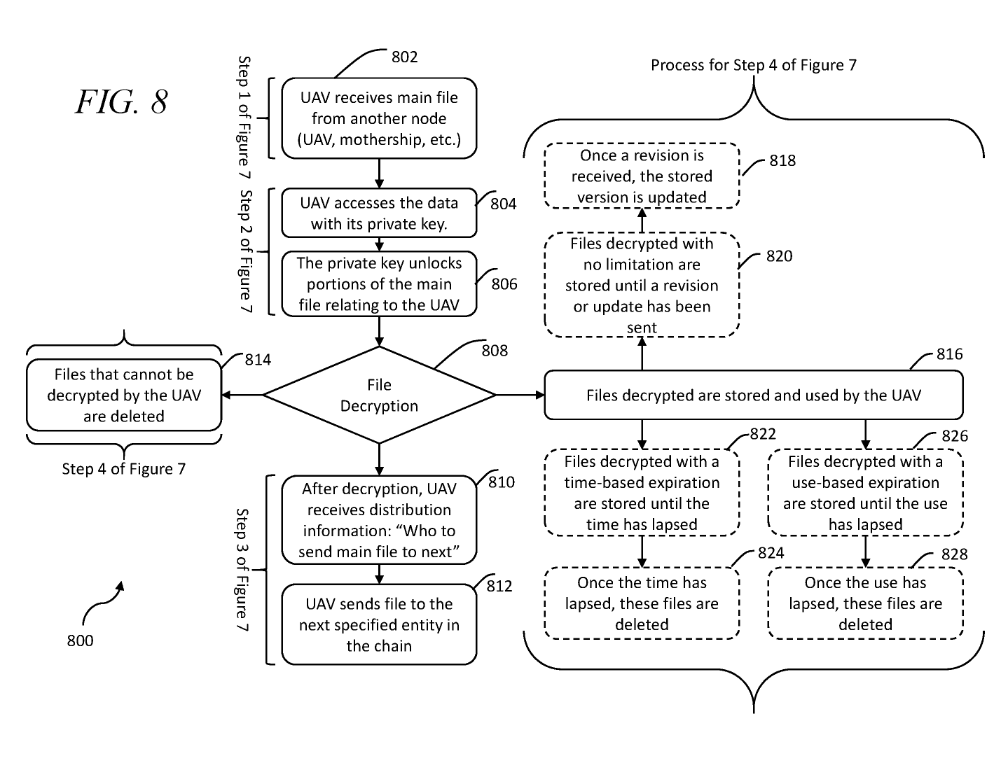

Referring to FIG. 7, there is shown another system 700 for using multiple UAVs defining a delivery chain to deliver merchandise items. This system 700 generally involves the transfer of the hash chain database between UAVs with subsequent deletion of any portion that cannot be decrypted by the UAV. In other words, each UAV automatically prunes and deletes the unencrypted files that are of no use to the UAV. This approach seeks to reduce the processing and/or storage demands on the UAVs by deleting as much of the unnecessary part of the hash chain database as possible immediately after transfer. Under this approach, the hash chain database may be transferred from UAV to UAV. In other words, the hash chain database may be stored in the memory device 208 of the starting UAV (UAV A (706)) and may then be communicated from the memory device 208 of each transferring UAV to the memory device 208 of each corresponding transferee UAV receiving the merchandise item. This approach is in contrast to the systems 300 and 600 described above, which involved the use of a centralized storage and processing node and a distributed database.

In FIG. 7, there is shown a mothership or command and control center 702 that hosts the hash chain database (main file) 704. It is generally contemplated that the mothership or command and control center 702 has more resources and capability for storing and processing the hash chain database 704. Further, the mothership and command and control center 702 are just two examples used herein, and it is also contemplated that the hash chain database 704 may be hosted in other ways (such as via a cloud-based platform).

The system 700 generally utilizes the UAVs 200 having the same components as described above (motorized flight system 202, navigational system 204, merchandise storage or securement system 206, memory device 208, transceiver 210, and control circuit 212). In the example of system 700, FIG. 7 shows three UAVs (UAV A (706), UAV B (708), and UAV C (710)). As can be seen, each UAV receives the hash chain database (main file) 704 and transmits the main file 704 to the next UAV. UAV A (706) receives the main file 704 from the mothership or command and control center 702 and transmits it to UAV B (708), which, in turn, transmits the main file 704 to UAV C (710).

FIG. 7 also shows four steps that are taken to handle the main file 704 at each UAV, and these steps are addressed in greater detail in FIG. 8. First, as shown at block 712, each UAV receives the main file 704. Second, as shown at block 714, each UAV processes and decrypts portions of the main file 704. Third, as shown at block 716, each UAV transmits the main file 704 to the next UAV in the delivery chain, unless the UAV is already the last UAV in the delivery chain. Fourth, as shown at block 718, each UAV deletes the portions of the main file 704 that it cannot decrypt and uses the portions of the main file 704 that it can decrypt. Generally, the UAV decrypts the portion of the main file 704 that pertain to that UAV, i.e., flight path, flight destination, identity of the other UAVs transferring and/or receiving the merchandise item, etc.

FIG. 8 shows a process 800 in which these steps in FIG. 7 are shown in greater detail. At block 802, with respect to step 1, each UAV receives the hash chain database (or main file) in sequential order as each UAV is arranged in the delivery chain. In other words, each UAV receives the main file from another node (transferring UAV, mothership, etc.) The first UAV (UAV A (706)) receives it from the mothership or command and control center 702, while the other UAVs (UAV B (708) and UAV C (710)) receive the main file from the immediately preceding UAV in the delivery chain (either UAV A (706) or UAV B (708)).

At blocks 804, 806, and 808, with respect to step 2, each UAV decrypts the main file. At block 804, in this form, the UAV uses its private key to access the data in the main file, and at block 806, the private key unlocks portions of the main file relating to that particular UAV (delivery parameters). Theses portion of the main file (delivery parameters) may include, for example, flight information for that UAV (such as the location coordinates for receipt of the merchandise item from a UAV transferring the merchandise item, the location coordinates for transfer of the merchandise item to a transferee UAV, coordinates of the delivery location, flight path, and any other desirable flight information) and authentication information (such as authentication information for the transferring UAV and the authentication information for the transferee UAV). Block 808 shows the decryption of the portions of the main file that relate to that particular UAV. It is generally contemplated that this decryption occurs locally at the UAV.

After decryption, with respect to step 3, each UAV transmits the main file to the next UAV in the delivery chain. As shown at block 810, following decryption, the UAV receives distribution information as to which UAV should receive the main file next, and at block 812, the UAV transmits the main file to the next specified entry in the delivery chain. As should be evident, if the UAV is the last UAV in the delivery chain, this step may be omitted because there is no subsequent UAV to receive the main file. It is generally contemplated that this transmission of the main file occurs immediately after decryption of the portions of the main file that relate to that particular UAV. Once the main file is transmitted to the next UAV in the delivery chain, the decrypting UAV can immediately delete the main file, which may otherwise affect and impede the processing and storage capability of the decrypting UAV. So, it is generally desirable to transmit the main file right away so that the decrypting UAV is no longer burdened with it.

Following decryption and transmission, with respect to step 4, each UAV may then delete the undecrypted portions of the main file and may use the decrypted portions of the main file (the delivery parameters that pertain to that particular UAV). As shown at block 814, the portions of the main file that do not relate to that particular UAV and that cannot be decrypted are “automatically pruned.” In other words, files that cannot be decrypted by the UAV are deleted, and preferably, this deletion occurs immediately after transmission of the main file to the next UAV, if applicable.

As shown at block 816, with respect to decrypted portions of the main file, these decrypted portions are stored and used by the UAV. As can be seen in FIG. 8, these decrypted portions may be used in various ways and may be deleted when no longer needed. For example, at block 818 and 820, some or all of the decrypted portions may be stored indefinitely. At block 818, some or all of these decrypted files have no limitation on storage and may be stored indefinitely until a revision or update to those files has been received by UAV. At block 820, if a revision is received by the UAV, the stored version may then be updated.

Other examples of storage protocols are shown at blocks 822, 824, 826, and 828. As another example, some or all of the decrypted files may be stored for a certain length of time and then deleted. At blocks 822 and 824, decrypted files having a time-based expiration associated with them are stored until the predetermined time interval has elapsed, at which time they are deleted. In other words, undecrytped files may be deleted from the memory device 208 of each transferring UAV within a predetermined time following transfer of the merchandise item to each corresponding transferee UAV. As an additional example, some or all of the decrypted files may have a used-based expiration associated with them. At blocks 826 and 828, decrypted files having a use-based expiration are stored until the particular use has been accomplished, at which time they are deleted. In yet another form, it is contemplated that the hash chain database may be deleted in its entirety from the memory device of each transferring UAV within a predetermined time following transfer of the merchandise item to a transferee UAV (because it is assumed that the UAV has made complete use of the information in the hash chain database).

Various approaches have been described above for the handling of hash chain databases and blockchain, including processing conducted exclusively or primarily at a centralized node (system 300), distribution of the hash chain database to the UAVs (system 600), and transfer of the hash chain database from one UAV to the next with automatic pruning/deletion of unnecessary files (system 700). Another approach is now described that is a modified form of system 700. More specifically, in this modified form, the hash chain database is again transmitted from one UAV to the next UAV in the delivery chain, but each UAV receiving the hash chain database deletes all data relating to past successful and secure transfers but updates the hash chain database with a new block indicating a successful/secure transfer of the merchandise item from the previous UAV. In other words, the hash chain itself may be modified with significant deletions. In one form, in contrast to system 700, the entire main file is not transmitted from one UAV to the next, but instead, the main file is modified at each UAV so that only undecrypted portions are retained and transmitted, as well as blocks indicating past transfers of the merchandise item that were insecure/unsuccessful.

As long as there is a successful and secure transfer of the merchandise item, all blocks relating to past delivery parameters and past successful and secure transfers are automatically deleted as unnecessary information. In other words, the control circuit 212 of the receiving UAV may be configured to delete delivery parameters from the hash chain database relating to transfers of the merchandise item to UAVs in the delivery chain prior to the UAV's receipt of the merchandise item and update the hash chain database with a new block indicating successful and secure transfer of the merchandise item to the UAV. In this circumstance, if the last UAV updates the hash chain database with a block indicating a successful and secure transfer and there are no other blocks relating to past transfers, this last block indicates that all of the transfers were handled in a successful and secure manner. However, if at any stage, there is a block indicating an unsuccessful/insecure transfer or some other irregularity, this block is carried forward or duplicated such that the last UAV includes this block.

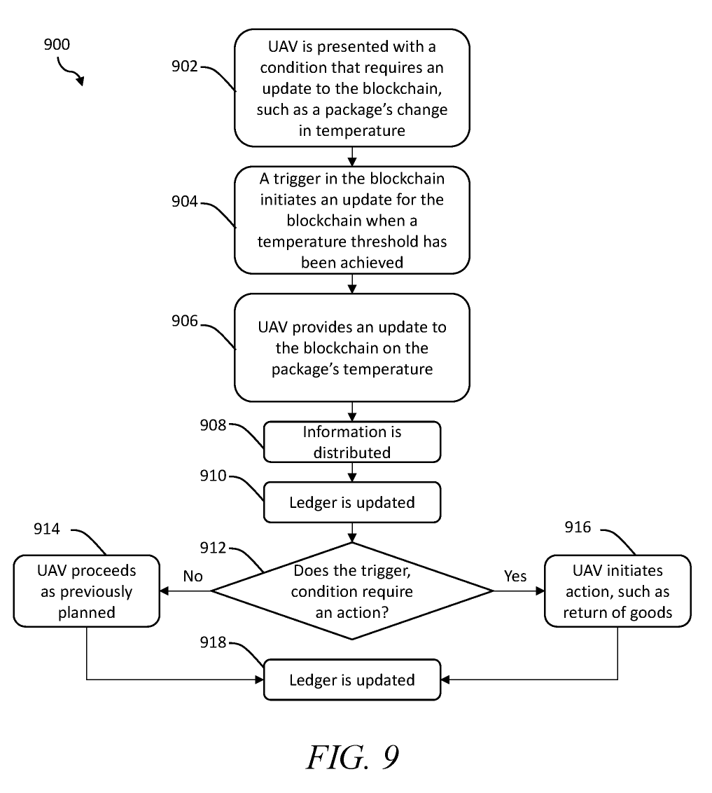

In addition to these various approaches for the handling of blockchain in the merchandise transfers between UAVs, it is also contemplated that blockchain may be used to monitor and update certain specific conditions. FIG. 9 shows a process 900 for monitoring and updating conditions relating to a delivery. In one form, it is contemplated that conditions relating to the merchandise item itself may be monitored, such as, for example, the temperature of the merchandise item, and the blockchain may be updated periodically regarding this condition.

At block 902, a UAV monitors a condition that has been decided should be updated in the blockchain, such as, for example, a package's change in temperature. For example, the merchandise being transported may be a perishable item (such as frozen grocery or medication) that must be maintained with a certain temperature range. In this example, it may be important to confirm that the perishable item has been maintained above or below a certain temperature threshold at all times during transport, i.e., cold chain compliance. Otherwise, the perishable item may have spoiled or may be otherwise unusable. Another example is a trigger when the battery power/fuel of the UAV reaches a certain minimum threshold, such as 5%, and this second example shows that the trigger/condition need not relate to the condition of the merchandise.

At block 904, a trigger is initiate to provide an update to the hash chain database/blockchain. For example, the UAV may include sensors (such as thermometers) for monitoring the desired conditions of the merchandise item. Further, in this example, these sensors may be configured to take continuous or periodic measurements of the merchandise item (such as, for example, taking temperature readings every five minutes). Alternatively, or in addition, measurements may be taken at specific points and events (at takeoff of the UAV). These temperature measurements (or other condition measurements) may be compared to a predetermined threshold (minimum or maximum temperature) for the merchandise item.

At block 906, the UAV provides an update to the blockchain on the package's temperature (or other condition). In one form, a new block may be created for every temperature or other condition measurement. In another form, a new block may be created only if the temperature or condition exceeds the predetermined threshold, i.e., it is below a minimum temperature threshold or above a maximum temperature threshold. The conditions and triggers may provide a filter for when the blockchain needs to be updated. In this manner, a condition of the merchandise item may be monitored and a blockchain update generated during transport of the merchandise.

At blocks 908 and 910, information regarding the condition is distributed, which may, in turn, result in an update the hash chain database/ledger. This distribution and update may occur in different ways, depending on which of the above approaches for maintaining the hash chain database. For example, information may be transmitted to a centralized node (if the hash chain database is maintained at a centralized node), may be transmitted to one of the memory devices of the UAVs (if the hash chain database is maintained in a distributed manner across the UAVs), or may be stored in a new block by a UAV prior to transmission of the main file to a subsequent UAV (where the hash chain database is transferred in whole or in part from one UAV to the next UAV in the delivery chain).

At block 912, a decision is made as to whether the trigger condition requires action. In one form, this decision may be made at a remote command and control center, a mothership, or cloud-based platform. At block 914, if the trigger condition (temperature) does not require action (it does not exceed a predetermined temperature threshold), then the UAV may proceed along its delivery route to continue with the delivery. However, at block 916, if the trigger condition (temperature) does require action (it exceeds the predetermined temperature threshold), then the UAV may be instructed to initiate an action. For example, if the measured temperature is too high or too low, the UAV may be instructed to return the merchandise item to a predetermined handling location. At block 918, the ledger may be updated with this information (continue along delivery route, return goods, etc.) In summary in one form, the hash chain database may include a condition relating to the merchandise item (such as temperature); each UAV may include a sensor for measuring the condition of the merchandise item (such as a thermometer); and each UAV may update the hash chain database with a block indicating a change in condition or no change in condition.

The various systems and processes disclosed herein have addressed the use of hash chain databases and blockchain in the context of transfers between and operations by UAVs in a delivery chain. It is generally contemplated that the general operation and updating of such hash chain databases and blockchain may be accomplished in various ways. Some of these approaches regarding the general operation and updating of hash chain databases and blockchain are addressed below.

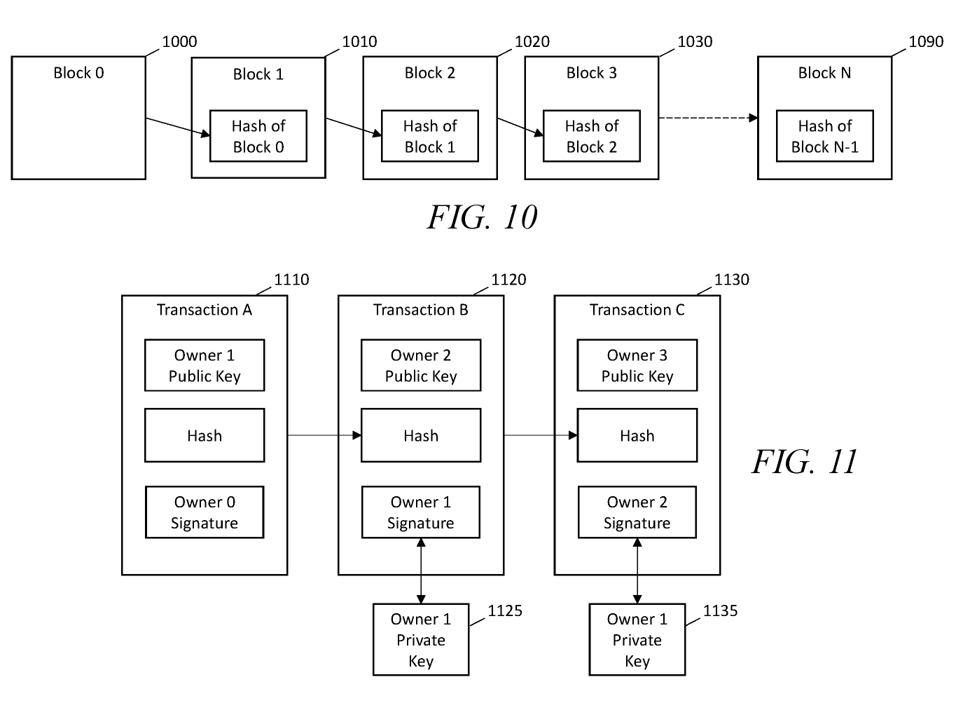

Descriptions of some embodiments of blockchain technology are provided with reference to FIGS. 10-15 herein. In some embodiments of the invention described above, blockchain technology may be utilized to record merchandise transfers, transactions, authentications, and changes and updates to delivery parameters/conditions. One or more of the UAVs, remote command and control center, mothership, and/or cloud-based platform described herein may comprise a node in a distributed blockchain system storing a copy of the blockchain record. Updates to the blockchain may comprise transfers of merchandise, authentications, delivery parameters, merchandise conditions, and other data, and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 10, an illustration of a blockchain according to some embodiments is shown. In some embodiments, a blockchain comprises a hash chain or a hash tree in which each block added in the chain contains a hash of the previous block. In FIG. 10, block 0 1000 represents a genesis block of the chain. Block 1 1010 contains a hash of block 0 1000, block 2 1020 contains a hash of block 1 1010, block 3 1030 contains a hash of block 2 1020, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners' are nodes that compete to provide proof-of-work to form a new block, and the first successful miner of a new block earns Bitcoin currency in return.

Now referring to FIG. 11, an illustration of blockchain based transactions according to some embodiments is shown. In some embodiments, the blockchain illustrated in FIG. 11 comprises a hash chain protected by private/public key encryption. Transaction A 1110 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 1120 comprises the public key of owner 2 (recipient), a hash of the previous block, and owner 1's signature for the transaction that is signed with the owner 1's private key 1125 and verified using owner 1's public key in transaction A 1110. When owner 2 transfers the asset to owner 3, a block containing transaction C 1130 is formed. The record of transaction C 1130 comprises the public key of owner 3 (recipient), a hash of the previous block, and owner 2's signature for the transaction that is signed by owner 2's private key 1135 and verified using owner 2's public key from transaction B 1120. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 11 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

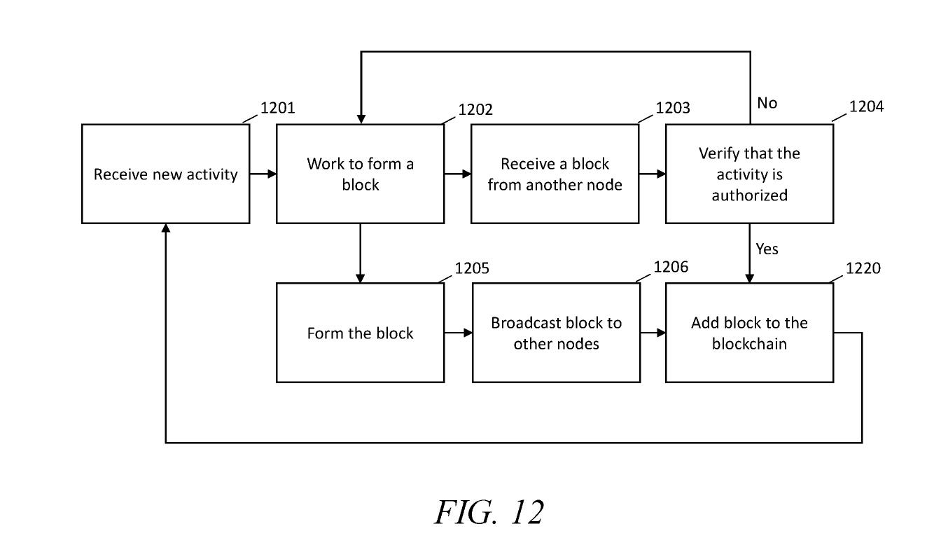

Now referring to FIG. 12, a flow diagram according to some embodiments is shown. In some embodiments, the steps shown in FIG. 12 may be performed by a processor-based device, such as a computer system, a server, a distributed server, a timestamp server, a blockchain node, and the like. In some embodiments, the steps in FIG. 12 may be performed by one or more of the nodes in a system using blockchain for record keeping.

In step 1201, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 1201. In step 1202, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 1202, if the node successfully forms a block in step 1205 prior to receiving a block from another node, the node broadcasts the block to other nodes over the network in step 1206. In some embodiments, in a system with incentive features, the first node to form a block may be permitted to add incentive payment to itself in the newly formed block. In step 1220, the node then adds the block to its copy of the blockchain. In the event that the node receives a block formed by another node in step 1203 prior to being able to form the block, the node works to verify that the activity recorded in the received block is authorized in step 1204. In some embodiments, the node may further check the new block against system consensus rules for blocks and activities to verify whether the block is properly formed. If the new block is not authorized, the node may reject the block update and return to step 1202 to continue to work to form the block. If the new block is verified by the node, the node may express its approval by adding the received block to its copy of the blockchain in step 1220. After a block is added, the node then returns to step 1201 to form the next block using the newly extended blockchain for the hash in the new block.

In some embodiments, in the event one or more blocks having the same block number is received after step 1220, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 1201.

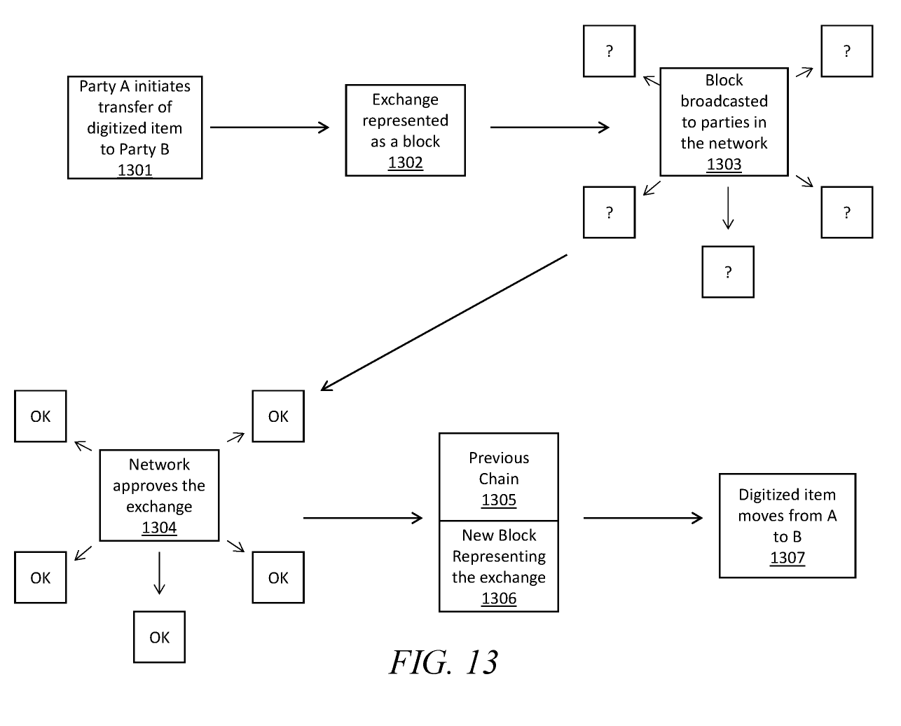

Now referring to FIG. 13, a process diagram a blockchain update according to some implementations in shown. In step 1301, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 1302, the exchange initiated in step 1301 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 1303, the block is broadcasted to parties in the network. In step 1304, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 1306 representing the exchange is added to the existing chain 1305 comprising blocks that chronologically precede the new block 1306. The new block 1306 may contain the transaction(s) and a hash of one or more blocks in the existing chain 1305. In some embodiments, each node may then update their copy of the blockchain with the new block and continue to work on extending the chain with additional transactions. In step 1307, when the chain is updated with the new block, the digitized item is moved from party A to party B.

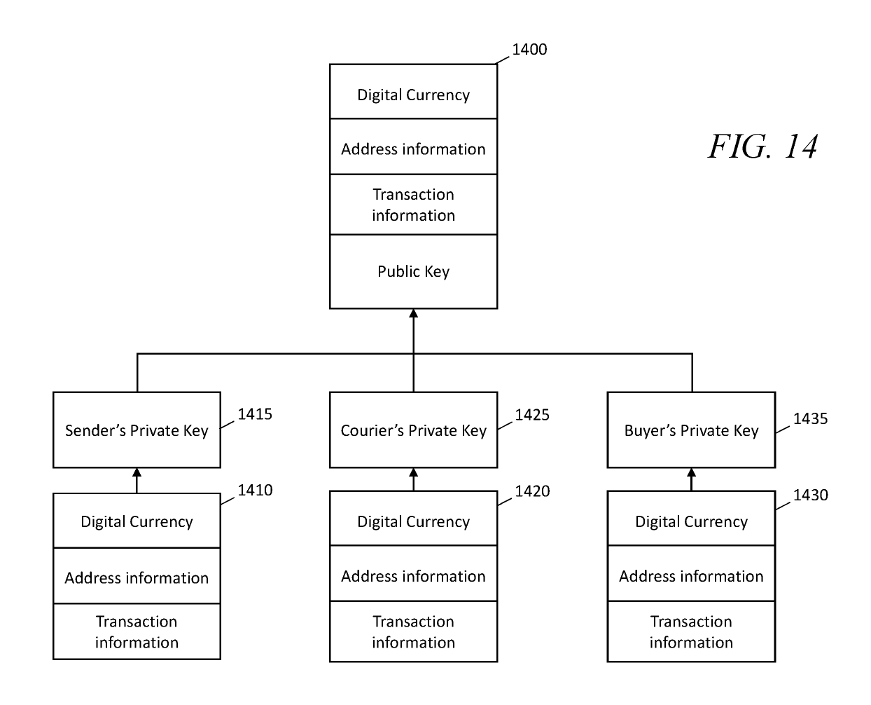

Now referring to FIG. 14, a diagram of a blockchain according to some embodiments in shown. FIG. 14 comprises an example of an implementation of a blockchain system for delivery service record keeping. The delivery record 1400 comprises digital currency information, address information, transaction information, and a public key associated with one or more of a sender, a courier, and a buyer. In some embodiments, nodes associated the sender, the courier, and the buyer may each store a copy of the delivery record 1410, 1420, and 1430 respectively. In some embodiments, the delivery record 1400 comprises a public key that allows the sender, the courier, and/or the buyer to view and/or update the delivery record 1400 using their private keys 1415, 1425, and the 1435 respectively. For example, when a package is transferred from a sender to the courier, the sender may use the sender's private key 1415 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 1425 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 14, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

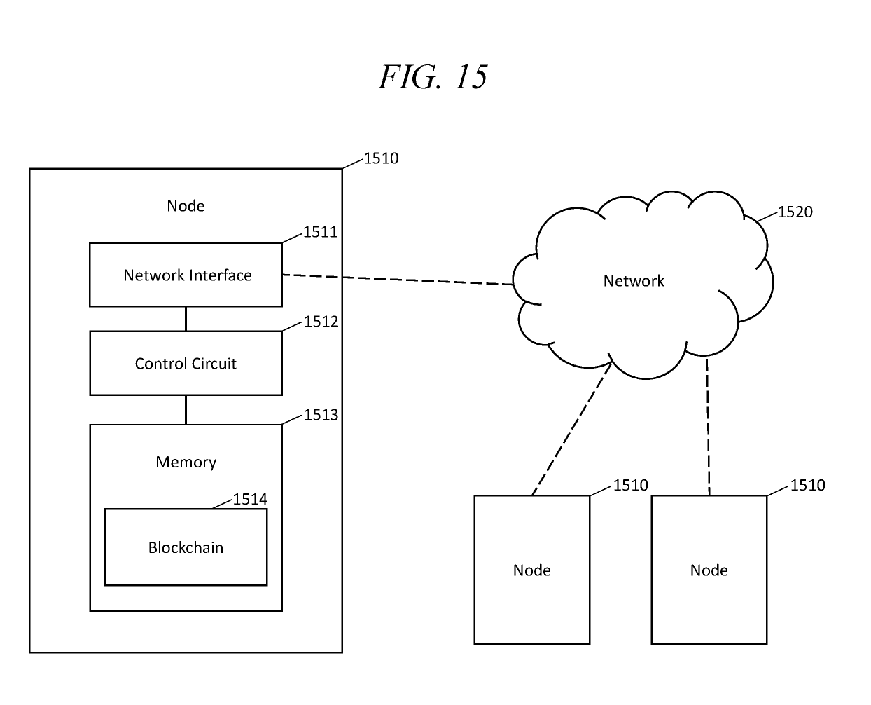

Now referring to FIG. 15, a system according to some embodiments is shown. A distributed blockchain system comprises a plurality of nodes 1510 communicating over a network 920. In some embodiments, the nodes 1510 may be comprise a distributed blockchain server and/or a distributed timestamp server. In some embodiments, one or more nodes 1510 may comprise or be similar to a “miner” device on the Bitcoin network. Each node 1510 in the system comprises a network interface 1511, a control circuit 1512, and a memory 1513.

The control circuit 1512 may comprise a processor, a microprocessor, and the like and may be configured to execute computer readable instructions stored on a computer readable storage memory 1513. The computer readable storage memory may comprise volatile and/or non-volatile memory and have stored upon it a set of computer readable instructions which, when executed by the control circuit 1512, causes the node 1510 update the blockchain 1514 stored in the memory 1513 based on communications with other nodes 1510 over the network 1520. In some embodiments, the control circuit 1512 may further be configured to extend the blockchain 1514 by processing updates to form new blocks for the blockchain 1514. Generally, each node may store a version of the blockchain 1514, and together, may form a distributed database. In some embodiments, each node 1510 may be configured to perform one or more steps described with reference to FIGS. 12-13 herein.

The network interface 1511 may comprise one or more network devices configured to allow the control circuit to receive and transmit information via the network 1520. In some embodiments, the network interface 1511 may comprise one or more of a network adapter, a modem, a router, a data port, a transceiver, and the like. The network 1520 may comprise a communication network configured to allow one or more nodes 1510 to exchange data. In some embodiments, the network 1520 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, erase all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for the secure delivery of merchandise using a plurality of unmanned aerial vehicles forming a delivery chain, the system comprising:
a plurality of unmanned aerial vehicles (UAVs) for transporting a merchandise item, each UAV comprising:
a motorized flight system configured to facilitate flight of the UAV;
a navigational system for guiding the UAV along a flight path;
a merchandise storage or securement system configured to hold at least one merchandise item during flight;
a memory device;
a transceiver configured for wireless communication;
a UAV control circuit operatively coupled to the motorized flight system, the navigational system, and the transceiver, the control circuit configured to operate and fly the UAV;
a UAV delivery chain including a starting location wherein a starting UAV receives the merchandise item, a delivery location wherein a delivery UAV delivers the merchandise item, and one or more intermediate transfer locations between the starting and delivery locations wherein one of the plurality of UAVs transfers the merchandise item to another one of the plurality of UAVs;
a centralized storage and processing node configured to host a hash chain database containing delivery parameters associated with each of the plurality of UAVs and to update the hash chain database;
wherein each UAV control circuit is configured to communicate with the centralized node, via the transceiver, to cause the centralized node to:
retrieve delivery parameters assigned to the UAV from the hash chain database wherein the delivery parameters for the UAV is at least partially encrypted at the centralized node;
decrypt the delivery parameters assigned to the UAV with a public or private key of the UAV assigned to the UAV;
identify another UAV as a transferee to accept receipt of the merchandise item or, if the UAV is the delivery UAV, identify the delivery location wherein the delivery UAV delivers the merchandise item; and
update the hash chain database with a new block comprising a hash of preceding data in the hash chain database and delivery parameters encrypted with a public or private key of the UAV.

2. The system of claim 1, wherein the centralized node comprises a remote server and the hash chain database is stored on the remote server, each control circuit being configured to access the hash chain database and/or the delivery parameters from the remote server via each UAV's transceiver.

3. The system of claim 1 wherein the centralized node is physically incorporated into a dedicated master UAV of the plurality of UAVs, the dedicated master UAV configured with sufficient storage and processing capability to host and update the hash chain database.

4. The system of claim 1, wherein the hash chain database comprises a blockchain in which each block corresponds to delivery parameters for one of the plurality of UAVs.

5. The system of claim 1, wherein one or more blocks in the hash chain database comprise identification information of transferee UAVs assigned to accept receipt of the merchandise item from transferring UAVs.

6. The system of claim 1, wherein the control circuit of each transferring UAV is further configured to communicate with the centralized node to authenticate the transferee UAV based on vehicle registry information stored in the hash chain database.

7. The system of claim 1, wherein the delivery parameters for each UAV comprise at least one of the location coordinates for receipt of the merchandise item from a UAV transferring the merchandise item, authentication information for the transferring UAV, the location coordinates for transfer of the merchandise item to a transferee UAV, the authentication information for the transferee UAV, and the coordinates of the delivery location.

8. The system of claim 1, wherein the merchandise storage or securement system of each UAV comprises a gripper mechanism configured to selectively grasp, hold, and release the merchandise item.

9. The system of claim 1, wherein a private key for each UAV is stored in the UAV's memory device and is transmitted to the centralized node for decrypting the UAV's delivery parameters at the centralized node.

10. The system of claim 1, wherein each UAV transmits a unique identification code associated with the UAV to the centralized node to allow the centralized node to determine the UAV's private key for decrypting the UAV's delivery parameters at the centralized node.

11. A method for the secure delivery of merchandise using a plurality of unmanned aerial vehicles forming a delivery chain, the method comprising:
providing a plurality of unmanned aerial vehicles (UAVs) for transporting a merchandise item, each UAV comprising:
a motorized flight system configured to facilitate flight of the UAV;
a navigational system for guiding the UAV along a flight path;
a merchandise storage or securement system configured to hold at least one merchandise item during flight;
a memory device;
a transceiver configured for wireless communication;
a UAV control circuit operatively coupled to the motorized flight system, the navigational system, and the transceiver, the control circuit configured to operate and fly the UAV;
defining a UAV delivery chain including a starting location wherein a starting UAV receives the merchandise item, a delivery location wherein a delivery UAV delivers the merchandise item, and one or more intermediate transfer locations between the starting and delivery locations wherein one of the plurality of UAVs transfers the merchandise item to another one of the plurality of UAVs;
by a centralized storage and processing node, hosting a hash chain database containing delivery parameters associated with each of the plurality of UAVs and updating the hash chain database;
by each UAV control circuit, communicating with the centralized node, via the transceiver, to cause the centralized node to:
retrieve delivery parameters assigned to the UAV from the hash chain database wherein the delivery parameters for the UAV is at least partially encrypted at the centralized node;
decrypt the delivery parameters assigned to the UAV with a public or private key of the UAV assigned to the UAV;
identify another UAV as a transferee to accept receipt of the merchandise item or, if the UAV is the delivery UAV, identify the delivery location wherein the delivery UAV delivers the merchandise item; and
update the hash chain database with a new block comprising a hash of preceding data in the hash chain database and delivery parameters encrypted with a public or private key of the UAV.

12. The method of claim 11, further comprising, by the control circuit of each transferring UAV, communicating with the centralized node to authenticate the transferee UAV based on vehicle registry information stored in the hash chain database.

13. The method of claim 11, further comprising, by each UAV control circuit, causing the transmission of a private key for the UAV stored in the UAV's memory device to the centralized node for decrypting the UAV's delivery parameters at the centralized node.

14. The method of claim 11, further comprising, by each UAV control circuit, causing the transmission of a unique identification code associated with the UAV to the centralized node to allow the centralized node to determine the UAV's private key for decrypting the UAV's delivery parameters at the centralized node.

15. A system for the secure delivery of merchandise using a plurality of unmanned aerial vehicles forming a delivery chain, the system comprising:
a plurality of unmanned aerial vehicles (UAVs) for transporting a merchandise item, each UAV comprising:
a motorized flight system configured to facilitate flight of the UAV;
a navigational system for guiding the UAV along a flight path;
a merchandise storage or securement system configured to hold at least one merchandise item during flight;
a memory device;
a transceiver configured for wireless communication;
a UAV control circuit operatively coupled to the motorized flight system, the navigational system, and the transceiver, the control circuit configured to operate and fly the UAV;
a UAV delivery chain including a starting location wherein a starting UAV receives the merchandise item, a delivery location wherein a delivery UAV delivers the merchandise item, and one or more intermediate transfer locations between the starting and delivery locations wherein one of the plurality of UAVs transfers the merchandise item to another one of the plurality of UAVs;
a hash chain database containing delivery parameters associated with each of the plurality of UAVs;
wherein each UAV control circuit is configured to:
retrieve delivery parameters assigned to the UAV from the hash chain database wherein the delivery parameters for the UAV is at least partially encrypted;
decrypt the delivery parameters assigned to the UAV with a public or private key of the UAV assigned to the UAV;
identify another UAV as a transferee to accept receipt of the merchandise item or, if the UAV is the delivery UAV, identify the delivery location wherein the delivery UAV delivers the merchandise item; and
update the hash chain database with a new block comprising delivery parameters encrypted with a public or private key of the UAV.

16. The system of claim 15, wherein the hash chain database is:
stored in the memory device of the starting UAV; and
communicated from the memory device of each transferring UAV to the memory device of each corresponding transferee UAV receiving the merchandise item.

17. The system of claim 16, wherein the hash chain database is deleted from the memory device of each transferring UAV within a predetermined time following transfer of the merchandise item to each corresponding transferee UAV.

18. The system of claim 16, wherein, for each UAV:
the hash chain database comprises a first portion that can be decrypted by the UAV control circuit using the UAV's private key and a second portion that cannot be decrypted by the UAV control circuit using the UAV's private key;
each transferring UAV is configured to delete the second portion following transfer of the merchandise item to the corresponding transferee UAV.

19. The system of claim 15, wherein the hash chain database is stored on a distributed database comprising the memory devices of the plurality of the UAVs.

20. The system of claim 15, wherein each UAV control circuit is configured to:
delete delivery parameters from the hash chain database relating to transfers of the merchandise item to UAVs in the delivery chain prior to the transferee UAV's receipt of the merchandise item; and
update the hash chain database with a new block indicating successful and secure transfer of the merchandise item to the UAV.

21. The system of claim 15, wherein:
the hash chain database includes a condition relating to the merchandise item;
each UAV includes a sensor for measuring the condition of the merchandise item; and
each UAV updates the hash chain database with a block indicating a change in condition or no change in condition.

22. The system of claim 20, wherein the condition is temperature and wherein each UAV includes a temperature sensor to measure the temperature of the merchandise item.
